(19) United States
(12) Patent Application Publication
(10) Pub. No.: US 2011/0176835 A1
(43) Pub. Date: Jul. 21, 2011

(54) TONER BEARING MEMBER, DEVELOPMENT DEVICE, AND IMAGE FORMING APPARATUS

(76) Inventors: Yasuyuki YAMASHITA, Kanagawa-ken (JP); Ryoichi Kitajima, Kanagawa-ken (JP)

(21) Appl. No.: 13/010,334

(22) Filed: Jan. 20, 2011

(30) Foreign Application Priority Data
Jan. 20, 2010 (JP) 2010-009715

(51) Int. Cl. G03G 15/08

(52) U.S. Cl. 399/252

(57) ABSTRACT

A toner bearing member having an electroconductive substrate, an insulation layer formed on the electroconductive substrate, multiple electrodes spaced a constant distance apart therebetween, formed on the insulation layer, and a surface layer that covers the multiple electrodes, the surface layer comprising a polymerizable material comprising a structure unit represented by the following chemical structure 1 and at least one of cyclohexanone and cyclopentanone,

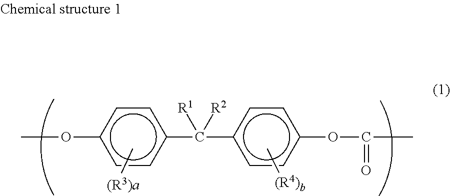

where R₁ and R₂, each, independently represent a hydrogen atom, an alkyl group, or an aryl group, or form a cyclic hydrocarbon residual group having 5 to 8 carbon atoms, R₃ and R₄, each, independently represent a hydrogen atom, a halogen atom, an alkyl group, or an aryl group, and “a” and “b” represent integers of 1 or 2.

### BACKGROUND OF THE INVENTION

1. Field of the Invention

The present invention relates to a toner bearing member, a development device incorporating the toner bearing member, and an image forming apparatus incorporating the development device.

2. Description of the Background Art

Image forming apparatuses such as photocopiers and printers use development devices employing electrophotography. Among such development devices, of note are non-contact-type development devices, in which a developer (e.g., toner) is transferred with the development devices not contacting an image bearing member on which a latent electrostatic image is formed.

Specific examples of such non-contact systems include a powder round method, a jumping method, and a method using an electric field curtain. Each of these approaches has strengths and weaknesses. For example, a voltage that detaches toner particles from the toner bearing member against the attractive force therebetween is necessary in the jumping method, in which the toner particles are caused to jump from the toner bearing member to the image bearing member to form the image.

In addition, in the electric field curtain method, preliminarily charged toner particles are caused to hop from the surface of the toner bearing member to the latent electrostatic image formed on the image bearing member by an electric field curtain generated by an alternating, non-uniform electric field developed on the surface of the toner bearing. This action is accomplished by applying an alternating electric field to multiple electrodes arranged inside the toner bearing member at a constant pitch. Since the toner particles hop on the surface of the toner bearing member, the attractive force between the toner particles and the surface of the toner bearing member is reduced to almost zero. Therefore, there is no need for a force to detach the toner particles from the surface of the toner bearing member, and thus transfer of the toner particles to the image bearing member can be accomplished with a low voltage.

Japanese patent application publication no. JP-H03-21967-A describes a development device employing the electric field curtain system using a developer transferring and bearing member, in which the multiple electrodes are covered with a surface protection layer formed of an insulating material, etc. Therefore, leakage of the charge in the toner to the electrodes is prevented, thereby preventing poor hopping of the toner particles.

However, this development device contains an insulation layer formed of the same resin as the surface protection layer. Therefore, the insulation layer is dissolved when the surface protection layer is applied, so that the electrode provided to the insulation layer tends to short-circuit. In addition, the toner particles are preliminarily friction-charged, that is, not charged by friction between the toner particles and the developer bearing and transferring member while the toner particles are hopping.

By contrast, JP-2007-310355-A and JP-2007-133388-A describe a development device having a developer bearing and transferring member formed of a material that helps friction-charging of toner particles with a regular polarity to charge the toner particles supplied to the surface of the toner bearing and transferring member without preliminary friction-charging while the toner particles are made to hop by an alternating electric field.

However, even when the surface layer is formed of an insulating material or material that helps friction-charging of toner particles with a regular polarity, if the toner particles are excessively friction-charged, the toner particles cannot hop from the surface layer but remain stuck thereon because the increased attractive force between the toner particles and the surface layer is stronger than the force applied by the electric field to the toner particles to cause the particles to hop. Therefore, the toner particles are not sufficiently charged, which prevents formation of a requisite toner cloud, resulting in production of abnormal images.

In addition, even when a suitable toner cloud is formed and proper images are produced initially, the balance between the attractive force and the hopping of the toner particles tends to erode over time because the abrasion of the roller changes the electric field formed by the electrodes arranged inside the toner bearing member, the abraded (roughened) surface of the roller prevents consistent transfer of the toner particles to the surface layer (resulting in changes in the amount of charge in the toner particles), and the attachment property of the toner bearing member with the toner particles changes. Therefore, the toner particles easily attach to the toner bearing member and do not hop sufficiently even when the toner particles are affected by the electric field generated by the electrodes inside the toner bearing member, which makes it difficult to produce quality images, resulting in production of images having a thin density, etc.

The present inventors have found that a suitable toner cloud is formed by forming the surface layer of a toner bearing member using a material containing a polycarbonate resin. However, polycarbonate resins are not easily attached to the insulation layer and the electrodes and tend to peel off during usage, resulting in production of abnormal images.

### SUMMARY OF THE INVENTION

For these reasons, the present inventors recognize that a need exists for a toner bearing member that has a polycarbonate surface layer that does not peel off, stably forms a toner cloud for an extended period of time, and supplies toner to a latent electrostatic image on an image bearing member to visualize the latent electrostatic image, a development device that contains the toner bearing member, and an image forming apparatus including the development device.

Accordingly, the present invention provides a toner bearing member that has a polycarbonate surface layer that does not peel off, stably forms a toner cloud for an extended period of time, and supplies toner to a latent electrostatic image on an image bearing member to visualize the latent electrostatic image, a development device that contains the toner bearing member, and an image forming apparatus including the development device.

Briefly this object and other objects of the present invention as hereinafter described will become more readily apparent and can be attained, either individually or in combination thereof, by a toner bearing member having an electroconductive substrate, an insulation layer formed on the electroconductive substrate, multiple electrodes multiple electrodes spaced a constant distance apart, formed on the insulation layer, and a surface layer that covers the multiple electrodes, the surface layer containing a polymerizable material having a structure unit represented by the following chemical structure 1 and cyclohexanone and/or cyclopentanone,

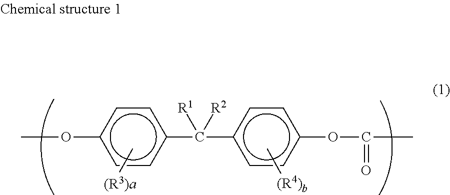

where R₁ and R₂, each, independently represent a hydrogen atom, an alkyl group, or an aryl group, or form a cyclic hydrocarbon residual group having 5 to 8 carbon atoms, R₃ and R₄, each, independently represent a hydrogen atom, a halogen atom, an alkyl group, or an aryl group, and “a” and “b” represent integers of 1 or 2.

It is preferred that, in the image bearing member described above, the polymerizable material has a polymerization average molecular weight of from 18,000 to 80,000.

It is still further preferred that, in the image bearing member described above, the insulation layer contains an alkyd-melamine resin.

It is still further preferred that, in the image bearing member described above, the surface layer contains cyclohexanone and/or cyclopentanone in an amount of from 0.01% to 12% by weight.

It is still further preferred that, in the image bearing member described above, the surface layer contains a better solvent for the polymerizable material than one or both of cyclohexanone and cyclopentanone.

It is still further preferred that, in the image bearing member described above, the surface layer contains a liquid application in which cyclohexanone and/or cyclopentanone is mixed with the better solvent in an amount of from 3% to 50% by weight.

It is still further preferred that, in the image bearing member described above, the liquid application is dried at 160° C. for 50 to 120 minutes.

As another aspect of the present invention, a development device is provided which has the toner bearing member described above and a toner supplying device that supplies toner to the toner bearing member.

As another aspect of the present invention, an image forming apparatus is provided which includes an image bearing member that bears a latent electrostatic image, a charging device that charges a surface of the image bearing member, an irradiator that irradiates the surface of the image bearing member to form a latent electrostatic image on the image bearing member, a development device that develops the latent electrostatic image with toner, the development device having the toner bearing member described above, a transfer device that transfers the visualized toner image onto a recording medium, and a voltage applicator that applies a voltage between the multiple electrodes of the toner bearing member and the image bearing member to form an electric field that is periodically reversed between the multiple electrodes and the image bearing member.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic diagram illustrating a cross section of an embodiment of an image forming apparatus related to the present disclosure;

FIG. 2 is a diagram illustrating the cloud state of toner in an embodiment of the development device of the present disclosure;

FIG. 3 is a diagram illustrating an example of the structure of toner bearing member of the present disclosure; and

FIG. 4 is a diagram illustrating another example of the structure of toner bearing member of the present disclosure.

### DETAILED DESCRIPTION OF THE PRESENT DISCLOSURE

Embodiments of the present disclosure are described with reference to the accompanying drawings.

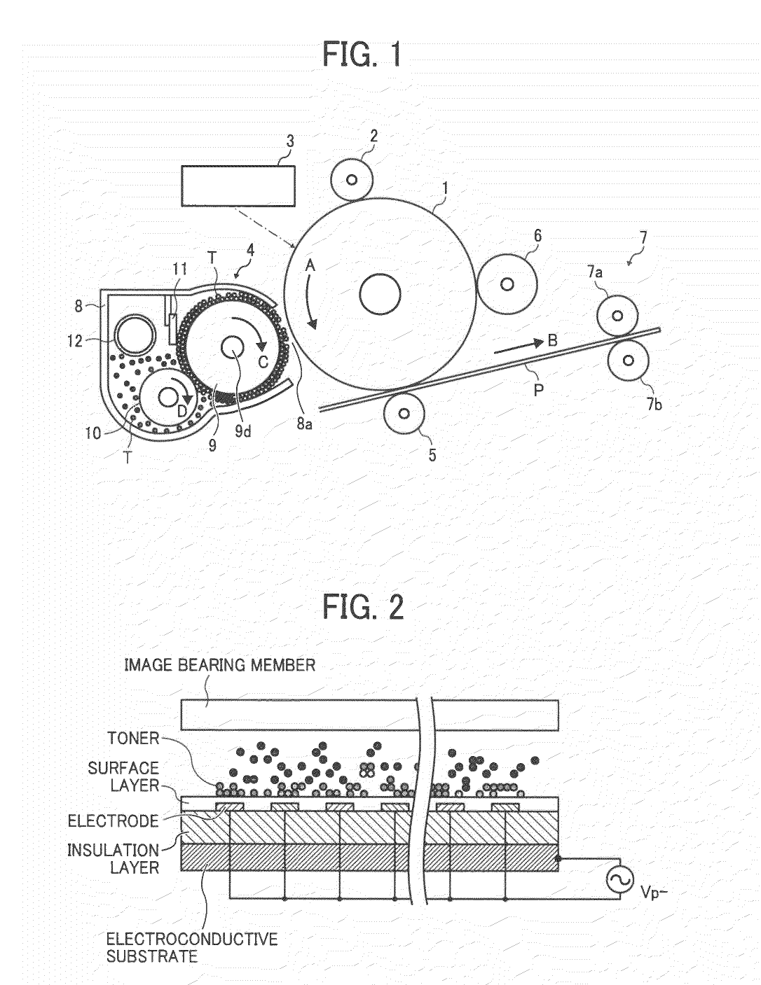

FIG. 1 is a schematic diagram illustrating an embodiment of an image forming apparatus related to the present disclosure.

In FIG. 1, the reference numeral 1 represents an image bearing member having a drum form that rotates in the direction indicated by an arrow A, the reference numeral 2 represents a charging roller that uniformly charges the surface of the image bearing member 1, the reference numeral 3 represents an irradiator that irradiates the surface of the image bearing member 1 with a laser beam according to image data, and the reference numeral 4 represents a development device that supplies toner to a latent electrostatic image formed on the surface of the image bearing member 1 to obtain a visualized image (toner image).

In addition, the reference numeral 5 represents a transfer roller that transfers the toner image formed on the surface of the image bearing member 1 by the development device 3 to a transfer medium P such as transfer paper, and the reference numeral 6 represents a cleaning device that removes residual toner remaining on the surface of the image bearing member 1 after transferring the toner image to the transfer medium P. The reference numeral 7 represents a fixing device that fixes the unfixed transfer toner image on the transfer medium P upon application of heat and pressure.

A method of forming toner images on the transfer medium P by this image forming apparatus is described. The surface of the image bearing member 1 that rotates in the direction indicated by the arrow A is uniformly charged with a predetermined voltage by the charging roller 2. The irradiator 3 irradiates the surface of the thus uniformly charged image bearing member 1 with a laser beam according to acquired image data to form a latent electrostatic image on the surface of the image bearing member 1. The development device 4 supplies toner to the thus formed latent electrostatic image to electrostatically attach the toner thereto to visualize latent electrostatic image and obtain a toner image.

The thus obtained toner image is transferred from the surface of the image bearing member 1 to the surface of the transfer medium P by applying a bias while transferring the transfer medium P pressed against the surface of the image bearing member 1 by the transfer roller 5 in the direction indicated by an arrow B. Thereafter, the toner image transferred to the transfer medium P is fixed on the transfer medium P upon application of heat and pressure by a heating roller 7a and a pressure roller 7b contained in the fixing device 7. The toner remaining on the surface of the image bearing member 1 from which the toner image is transferred to the transfer medium P is removed by the cleaning device 6 and uniformly charged again by the charging roller 2.

Thereafter, the processes described above of forming a latent electrostatic image by the irradiator 3, developing the latent electrostatic image with toner by the development device 4 to obtain a toner image, transferring the toner image to the transfer medium P and cleaning the surface of the image bearing member 1 by the cleaning device 6 are repeated.

In the present disclosure, the latent electrostatic image formed on the surface of the image bearing member 1 is developed with toner by the development device 4. As illustrated in FIG. 1, the development device 4 in the present disclosure includes a toner bearing member 9 that supplies a toner T from an opening mouth 8a to the image bearing member 1. The toner bearing member is rotatably attached to a container 8 that accommodates the toner T so that the toner bearing member is rotated in the direction indicated by an arrow C by a driving device (not shown) applied to the axis 9d of the toner bearing member 9.

A circulation paddle 10 circulates and stirs the toner T while rotating in the direction indicated by an arrow D to charge it and supplies the toner T to the surface of the toner bearing member 9.

The toner bearing member 9 to which the toner T is thus supplied scoops up the toner T while holding the toner T on the surface by the electrostatic force. The amount of the toner T scooped up is regulated by a toner layer regulator 11 having a blade form attached to the container 8 with a predetermined pitch to the toner bearing member 9. An alternating electric field is applied to the toner bearing member 9 at the opening mouth 8a to form cloud of the toner T, which is described later. Consequently, the toner T is electrostatically supplied from this cloud to the surface of the image bearing member 1 to form a toner image thereon. The reference numeral 12 represents a toner supply mouth from which the toner T is replenished.

The toner bearing member 9 is described next.

As illustrated in FIG. 2, the toner bearing member 9 has a laminate structure in which an electroconductive substrate, an insulation layer, an electrode pattern, an adhesive layer, and a surface layer are arranged in that order from below.

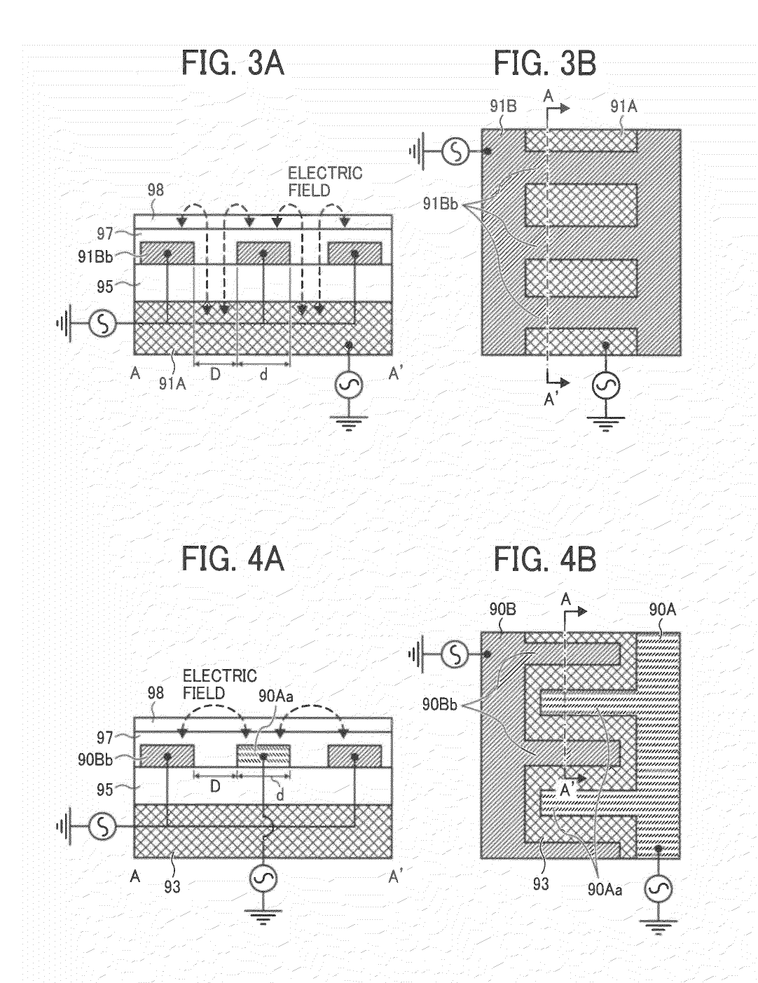

FIG. 3 is a diagram illustrating the toner bearing member 9.

As illustrated in FIGS. 3A and 3B, the toner bearing member 9 has a first electrode and a second electrode. FIG. 3A is a cross section by a line A-A′ of a top view of FIG. 3B. The electroconductive substrate 91A assumes one of the functions of the electrodes. When the electroconductive substrate 91A is A phase and an electrode pattern 91B having a multiple line form electrodes 91Bb formed on an insulation layer 95 is B phase, toner cloud is formed by hopping toner particles by the potential difference between the electroconductive substrate 91A and the electrode 91Bb.

The electrode pattern 91B is formed by forming a copper thin layer on the circumference of the electroconductive substrate 91A molded to have a cylindrical form by deposition followed by processing by a photoresist method to obtain a desired form. There is no specific limit to forming the electrode pattern 91B. Other than the photoresist patterning method, other known methods such as depicting using an ink jet recording device can be also suitably used. A substrate formed of a material having an excellent electroconductivity such as aluminum or an alloy thereof can be used as the electroconductive substrate 91A. In addition, there is no specific limit to the size of the electroconductive substrate 91A and any desired size can be selected. Furthermore, there is also no specific limit to a width d of the electrode 91Bb, a pitch D between the electrodes 91Bb. Any desired width and pitch can be selected. This is preferable because the pitch D can be set to be relatively wide in comparison with a pectinate electrode type described later, thereby preventing short-circuit.

The width d of the electrode pattern 91Bb, the pitch D, the alternating voltage, etc. affect formation of the toner cloud. To form a suitable toner cloud, the width d of the electrode pattern 91Bb is preferably from 40 to 250 μm, and the pitch D is preferably from 85 to 500 μm. The alternating voltage preferably has a frequency of from 100 to 5,000 Hz, and a voltage of from 100 to 3,000 V.

Any material having a high electroconductivity is suitable to form the electrode 91Bb. Using a paste material is preferable to depict an electrode pattern.

With regard to the toner bearing member 9 of this embodiment, a single phase alternating voltage is used as the alternating voltage power source. Also, an alternating voltage power source having multiple phases having different frequencies can be suitably used.

By applying a voltage periodically alternating negative and positive to the two electrodes provided to the toner bearing member 9, the electric field of the surface of the toner bearing member 9 periodically switches its direction. This temporary changes in the electric field cause the toner particles to hop between the surface of the image bearing member 1 and a surface layer 98 of the toner bearing member 9, resulting in formation of toner cloud. The toner T of this cloud is electrostatically attracted and attached to the latent electrostatic image formed on the surface of the image bearing member 1 to form a toner image.

### Electroconductive Substrate

Electroconductive substrates can be manufactured by, for example, forming a thin layer, for example, of a metal such as Al, Ag, and Au or an electroconductive material such as In₂O₃, and SnO₂ on a metal such as Al, Ni, Fe, Cu, and Au or an alloy thereof, or an insulated substrate made of polyester, polycarbonate, polyimide, glass or the like. Alternatively, an electroconductive resin substrate is suitably used which is formed by uniformly dispersing carbon black, graphite, or metal powder such as aluminum, copper, and nickel, or electroconductive glass powder, in a resin. Also, electroconductive-treated paper can be suitably used. These substrates preferably have a cylindrical form.

### Insulation Layer

The insulation layer is preferably made of a material different from the material constituting the adhesive layer.

Using the same material may result in dissolution of the insulation layer in a solvent contained in a liquid application for the adhesive layer when the adhesive layer is formed by a dipping method, or a spray coating method.

Dissolution of the insulation layer leads to disarrangement of the electrodes provided on the insulation layer, resulting in change in the distances between the electrodes. As a result, the electric field applied to the toner particles becomes too weak to cause the toner particles to hop, or the electrodes may be sunk in the insulation layer to contact with the electroconductive substrate, resulting in short-circuit of the electrodes, thereby losing the function of hopping the toner particles.

Particularly, with regard to materials such as polycarbonate that do not conduct cross-linking reaction during resin layer formation, the insulation layer may be severely damaged when forming the adhesive layer. Therefore, the insulation layer preferably contains a resin having a cross-linking structure.

Any resin that is not dissolved in a solvent contained in the liquid application for the adhesive layer can be used as the resin constituting the insulation layer.

Specific examples of such resins hardly soluble in an organic solvent include, but are not limited to, water soluble resins such as polyvinyl alcohol, casein, and sodium polyacrylate, alcohol soluble resins such as copolymer polyamide (copolymerized nylon) and methoxymethylized nylon, and curable resins which form a three dimensional mesh structure, such as polyurethane, melamine resins, alkyd-melamine resins, and epoxy resins. Among these, alkyd-melamine resins are suitably used.

The insulation layer can be formed by any known coating method using a suitable solvent.

Although it depends on materials, the insulation layer preferably has a thickness of from 1 to 100 μm and preferably to 50 μm.

An insulation layer that is too thin tends to make it difficult to prevent the charge leakage between the electrode and the toner particles.

An insulation layer that is too thick tends to weaken the electric field from the electrodes inside to a degree that the toner particles cannot hop from the surface layer.

### Surface Layer

To stably negatively charge toner particles, the surface of a toner bearing member that slidably abrades the toner particles is formed by a material containing an amino group. However, as a result of the inventive study made by the present inventors who have been looking for a material constituting the surface of the bearing member that stably forms toner clouds for an extended period of time, the present inventors have found that, by forming a surface layer containing a polymerizable material having a structure unit represented by the following chemical formula 1 which is free from an amino group by using a particular method, the toner bearing member can sustain a good combination of the friction charging of toner and the toner hopping to stably form toner clouds for an extended period of time and improve the abrasion resistance.

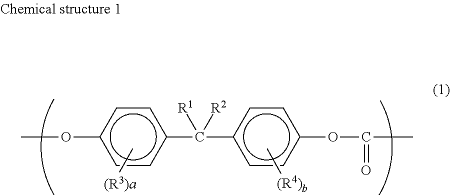

In Chemical structure 1, R¹ and R², each, independently represent a hydrogen atom, an alkyl group, or an aryl group, or form a cyclic hydrocarbon residual group having 5 to 8 carbon atoms, and R³ and R⁴, each, independently represent a hydrogen atom, a halogen atom, an alkyl group, or an aryl group. “a” and “b” represent an integer of 1 or 2.

That is, there are known things about polycarbonates as follows: (i) since bisphenol-based polycarbonate resins are non-crystalline, it has a suitable rigidity and flexibility with excellent shock-resistance.

Specific examples of good solvents include, but are not limited to, halogenated hydrocarbons such as methylene chloride, chloroform, 1,1,2,2-tetrachloroethane, and aromatic based solvent such as methacresol and pyridine. Specific examples of the slightly soluble solvents includes, but are not limited to, cyclic ethers such as thiophene, dioxane, and tetrahydrofuran (THF), ketone-based solvents such as acetone, methylethyl ketone, methyl isobutyl ketone, cyclrohexaone, and acetophenone, nitrogen-containing solvents such as benzonitrile and dimethyl formaldehyde (DMF), and some aromatic hydrocarbons. These are known to be insoluble in aliphatic hydrocarbons and aromatic hydrocarbons, aliphatic alcohols, carboxylic acids, and water. Among these, benzene is relatively of a high solubility than xylene or toluene and thus easy to be crystallized (according to “Polycarbonate Resin Handbook”, authored by Sei-ichi Honma, published on Aug. 28, 1992, on pages 22, 23, and 182, published by THE NIKKAN KOGYO SHIMBUN, LTD.); In addition, bisphenol-based polycarbonates are non-crystalline as described above because of its molecular chain structure, thereby having a suitable rigidity and flexibility with excellent shock-resistance (refer to pages 168, 169, and 200 of “Polycarbonate Resin Handbook”.

(ii) Polycarbonate is crystallized more easily by a solvent than heat treatment, and the solvent relatively easily remains (encapsulated). For example, the impact of the residual solvent on crystallization can be checked by the fact that, in the film having a layer thickness of from 500 to 1,000 Å prepared by methylene chloride solution of polycarbonate by a casting method, 0.75% methylene chloride remains (refer to page 180 of “Polycarbonate Resin Handbook”), and the remaining acetone is 0.5 wt % after a sample formed by drying a compression-molded film having a thickness of 0.4 mm using a polycarbonate having a molecular weight of 37,000 at 80° C. in vacuum for one day is exposed to acetone vapor at 25° C. for several days followed by drying at 60° C. (refer to page 180 of “Polycarbonate Resin Handbook”); (iii) Level of crystallization of polycarbonate depends on its molecular weight. For example, crystal having a spherical form is easily formed from methylene chloride solution of a polycarbonate sample having a molecular weight of 11,300, whereas crystal having a perfect spherical form is not formed from 0.1 to 1% methylene chloride thin solution of a polycarbonate sample having a molecular weight of 34,000 even when the solution is subject to a 11 to 14 hour evaporation treatment, or no crystal having a perfect spherical form is formed from methylene chloride solution of a polycarbonate sample having a molecular weight of 174,900. In addition, different from a solution induced crystalline film formed by crystallization by dipping using acetone, a non-crystalline film is easily dissolved in tetrahydrofuran (THF) (refer to page 182 of “Polycarbonate Resin Handbook”); and (iv) Crazing and cracking of polycarbonate occurs when a force lower than the yield stress point is continuously applied or after the induction time and before local molecular chain alignment (never occurs without alignment of molecular chain), which causes cracking of a molded polycarbonate product and reduces the adhesion strength. In addition, occurrence of crazing and cracking depends on the molecular weight. When the molecular weight of polycarbonate decreases, the induction time before crazing occurs is extremely shortened (refer to page 210, and 241 of “Polycarbonate Resin Handbook”).

Considering that these known facts, the present inventors have made an intensive study about the conditions with regard to various kinds of solvents that are required to obtain good combinations of characteristics such as adhesiveness, abrasion resistance, and electrostatic characteristics (stably forming toner cloud for an extended period of time, and preventing production of abnormal images). These conditions have not been suggested for known materials such as aromatic hydrocarbon solvents and halogenated solvents the use of which should be avoided in terms of human health. The present inventors have thus made the present invention.

The surface layer can employ a structure formed of laminate layers as long as the uppermost layer contains a polymerizable material containing the structure unit represented by the chemical formula 1 and the layer contacting with the insulation layer contains cyclohexanone and/or cyclopentanone.

Cyclohexanone and/or cyclopentanone contained in the surface layer preferably has a content of from 0.01% to 12% by weight, and more preferably from 0.05% to 10% by weight, and most preferably from 0.1% to 9% by weight.

When the content of cyclohexanone and/or cyclopentanone is too small, it may be difficult to secure the adhesiveness between the surface layer and the insulation layer.

To the contrary, when the content of cyclohexanone and/or cyclopentanone is too large, the solvent is hardly dried and thus the thin layer remains wet and sticky or a contact trace easily appears on the surface layer so that the obtained roller is not usable.

Specific examples of the structure contained in the Chemical formula 1 include, but are not limited to, the following.

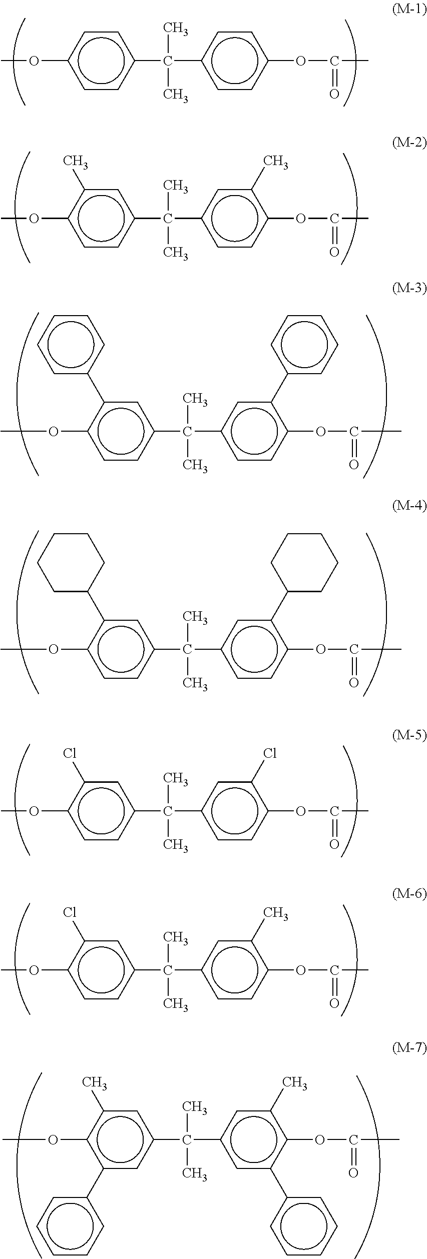

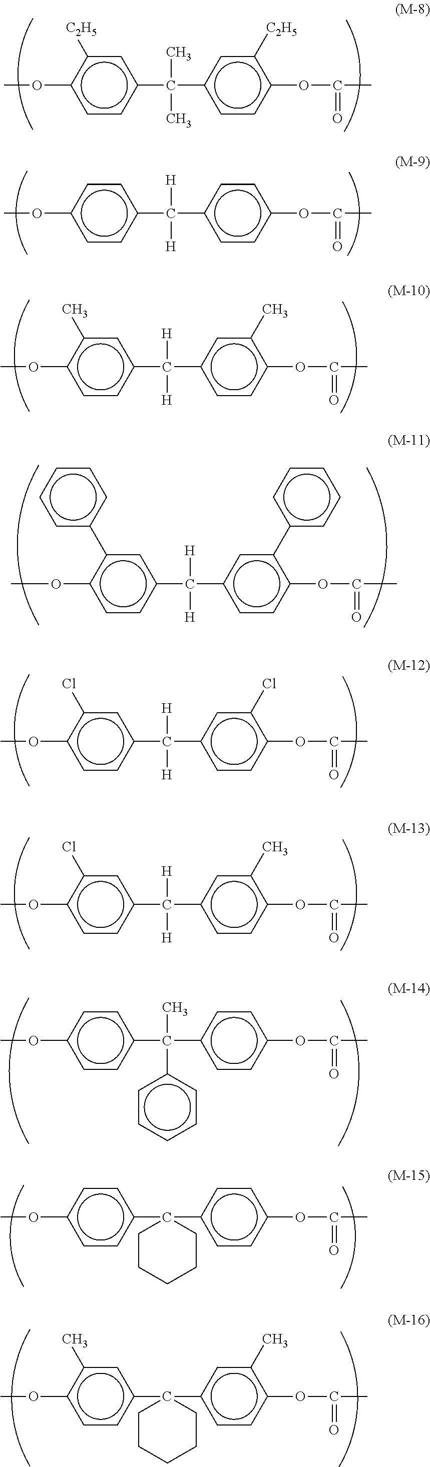

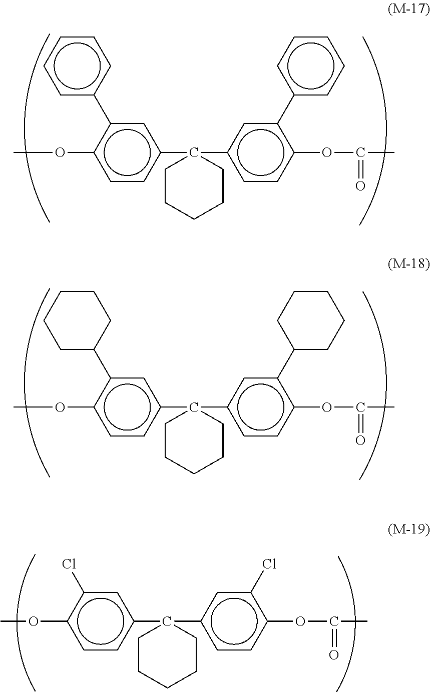

Among the polycarbonate resins illustrated above, bisphenol Z type polycarbonate resins are preferable.

Since bisphenol Z type polycarbonate resins have a high abrasion resistance, factors inducing toner attachment such as damage to the toner bearing member caused by abrasion hardly occur to the surface.

Different from a typical molecular weight of from 11,300 to 174,900, the range of the molecular weight of the polymerizable material is considerably narrow. The molecular weight ranges from 18,000 to 80,000 and more preferably from 30,000 to 60,000, which is preferable in terms of ease of handling when dissolved in a solvent.

When the molecular weight is too small, although the liquid application is easily prepared, durability of the obtained toner bearing member tends to be insufficient because the volume of polycarbonate extremely lessens due to rapid crystallization and molecular chain re-arrangement of polycarbonate in the surface layer formed on the toner bearing member by the prepared liquid application.

### Surface Layer

To stably negatively charge toner particles, the surface of a toner bearing member that slidably abrades the toner particles is formed by a material containing an amino group. However, as a result of the inventive study made by the present inventors who have been looking for a material constituting the surface of the bearing member that stably forms toner clouds for an extended period of time, the present inventors have found that, by forming a surface layer containing a polymerizable material having a structure unit represented by the Chemical structure 1 illustrated above which is free from an amino group by using a particular method, the toner bearing member can sustain a good combination of the friction charging of toner and the toner hopping to stably form toner clouds for an extended period of time and improve the abrasion resistance.

The surface layer may contain leveling agents as an additive to the polycarbonate resin.

Any known material can be used as the leveling agent and silicone oil based leveling agents are particularly preferable because they can impart a high smoothness in a minute amount.

Specific examples of the silicone oils include, but are not limited to, dimethyl silicone oil, methylphenyl silicone oil, methylhydrogene polysiloxane, alkyl-modified silicone oil, fluorine-modified silicone oil, polyether-modified silicone oil, alcohol-modified silicone oil, amino-modified silicone oil, epoxy-modified silicone oil, carboxyl-modified silicone oil, mercapto-modified silicone oil, higher aliphatic acid-modified silicone oil, and higher aliphatic acid containing silicone oil.

In addition, an agent such as a plasticizer, an anti-oxidant, and a leveling agent can be added in a suitable amount to the surface layer.

The surface layer is formed by a known application method such as dipping or spray coating using one or more kinds of solvents such as tetrahydrofuran that can dissolve a polycarbonate resin and cyclopentanone and/or cyclohexanone.

The reason why the surface layer containing cyclohexanone and/or cyclopentanone is firmly attached to the insulation layer is described next.

Although not so well as tetrahydrofuran (boiling point: 66° C.), cyclopentanone and cyclohexanone can dissolve polycarbonate resins and have a high affinity with each other.

Therefore, it can be said that cyclopentanone and cyclohexanone have an intermolecular force enough to dissolve polycarbonate resins.

In addition, since cyclopentanone and cyclohexanone are ketone, the intramolecular polarization thereof is strong to a certain degree so that the intermolecular force can be easily secured.

Therefore, when cyclopentanone and/or cyclohexanone is used as a solvent to dissolve polycarbonate resin, a slight amount of the solvent remains in the thin resin layer after the solvent is dried and functions as a bridge between the polycarbonate resin and the base material to secure the attractive force.

In addition, since the solubility of cyclopentanone and cyclohexanone to a polycarbonate resin is not so high as tetrahydrofuran, one of the thinkable reasons is that the volume contraction caused by configuration change and relaxation of the molecular chain, i.e., conformation change in folding of the molecule, of the resin ascribable to the solvent evaporation after the application of the surface layer is not so severe as tetrahydrofuran so that displacement to cancel the internal distortion is small.

It is well known in the molding resin field that ABS resin that has excellent elasticity is hot blended with polycarbonate to obtain PC/ABS polymer alloy which has ductility against stress application, thereby compensating brittleness of bisphenol-based polycarbonate while taking advantage of the hardness thereof. By contrast, the particular combinations described above are employed in the present disclosure to have a good combination of the hardness and ductility.

However, since the power of this solvent to dissolve polycarbonate is not so strong, it is not suitable to prepare a liquid application by using a single or combinational use of cyclopentanone and cyclohexanone.

Therefore, it is preferable to use a solvent mixture of cyclopentanone and/or cyclohexanone with other solvents such as tetrahydrofuran, which have an excellent power to dissolve a polycarbonate resin.

When the liquid application is applied by a spray coating method, the weight ratio of cyclopentanone and/or cyclohexanone to the other solvents having a better dissolution power, i.e., good solvents is preferably from 3 to 50%, and more preferably from 5 to 40%.

When the ratio is too high, the liquid tends to droop down on the formed layer after the liquid application is applied, thereby causing production of abnormal images.

When the ratio is too small, the formed layer tends to have a rough surface, causing production of abnormal images because more relaxed molecular arrangement in the liquid application resulting from a large amount of good solvents tends to lead to extreme volume contraction of the formed layer as the applied liquid application dries or is removed.

In the case of a dipping method, since the evaporating pressure of cyclohexanone (Bp=156° C.) and cyclopentanone (Bp=131° C.) is not high, if the amount thereof in the solvent mixture is increased, the liquid tends to droop down, disturbing the formation of the surface layer, and resulting in production of abnormal images.

By increasing the time of still standing after application of the surface layer, disturbing of the applied layer can be reduced. However, this may lead to deterioration of the working efficiency. Therefore, an excessively high ratio of cyclopentanone and/or cyclohexanone is not preferable.

Specific examples of the solvents mixed with cyclopentanone and/or cyclohexanone include, but are not limited to, solvents more or less having a dissolution power for polycarbonate resin and a relatively low boiling point (202° C. or lower) such as tetrahydrofuran (Bp=66° C.), pyridine (Bp=115.3° C.), dioxane (Bp=101.3° C.), thiophene (Bp=84.16° C.), methylisobutyl ketone (Bp=115.9° C.), diisobutyl ketone (Bp=168.1° C.), mehthlethyl ketone (Bp=79.64° C.), acetone (Bp=56.12° C.), 2-hexanone (Bp=127.2° C.), 3-pentanone (Bp=101.96° C.), 2-pentanone (Bp=102.26° C.), 2-heptanone (Bp=150.2° C.), 4-heptanone (Bp=144.05° C.), methylcyclohexanone (Bp=170° C.), (Bp=170° C.), acetophenone (Bp=202° C.), phrone (Bp=197.8° C.), and dimethylsulfoxide (Bp=189° C.). Among these, in terms of preparation and ease of handling the liquid application for the insulation layer, good solvents (=solvents having higher solubility) for polycarbonate resins are preferable.

Specific examples of the good solvents include, but are not limited to, cyclic ethers such as tetrahydrofuran and dioxane.

However, in terms of peeling resistance of the formed insulation layer, it is not necessarily preferable to use a good solvent having a low boiling point in an excessive amount, meaning that the amount of cyclopentanone and/or cyclohexanone is excessively small.

Considering that these contradicting two aspects of the preparation and ease of handling the liquid application for the insulation layer and the peeling resistance of the formed insulation layer, it is difficult to jump to any conclusion about the characteristics and amount of usage of the other solvents. However, it is certain that tetrahydrofuran and dioxane are suitable and thus, cyclopentanone and/or cyclohexanone in the solvent mixture is preferably contained in an amount of from 3% to 50% by weight as described above.

In addition, isophorone (Bp=215.2° C.) and m-cresol (Bp=202.7° C.) having a high dissolution power have a high boiling point so that polycarbonate tends to be crystallize during a long drying period of time, which is not preferable.

Although the drying conditions depend on the drying temperature, for example, the layer is preferably dried at 160° C. for 50 to 120 minutes as an indication. In Examples described later in detail, it takes about 30 minutes before the surface temperature of the base material reaches 155° C. Therefore, the roller is preferably dried for 20 to 100 minutes after the surface temperature of the base material reaches 155° C.

If the drying time is not long enough, the solvent is dried insufficiently and thus the thin layer is wet and sticky or a contact trace easily appears on the surface layer so that the obtained roller is not usable. However, a drying time that is excessively long is not preferable in terms of excessive annealing (re-arrangement of molecular chain, and volume contraction caused by crystallization) and the working efficiency.

With regard to the toner bearing member 9 of this embodiment, a single phase alternating voltage is used as the alternating voltage power source. Also, an alternating voltage power source having multiple phases having different frequencies can be suitably used. By applying a voltage periodically alternating negative and positive to the two electrodes provided to the toner bearing member 9, the electric field of the surface of the toner bearing member 9 periodically switches its direction. This temporary changes in the electric field cause the toner particles to hop between the surface of the image bearing member 1 and a surface layer 98 of the toner bearing member 9, resulting in formation of toner cloud. The toner T of this cloud is electrostatically attracted and attached to the latent electrostatic image formed on the surface of the image bearing member 1 to form a toner image.

Although there is no specific limit to the layer thickness of the surface layer as long as the surface layer forms an electric field curtain of toner on the surface of the toner bearing member and prevents exposure of the electrodes to the surface of the toner bearing member, the layer thickness is preferably from 0.5 to 50 μm.

A surface layer that is too thin tends to make it difficult to prevent charge leakage between the electrode and the toner particles.

When the surface layer is too thick, the electric field from the electrodes inside tends to become too weak to make the toner particles isolate and hop from the surface layer.

When the layer thickness is within this range, the toner particles stably hop.

As described above, in the present disclosure, toner cloud is stably formed for an extended period of time by using the polymerizable material represented by the chemical formula 1 contained in the surface of the toner bearing member employing a top and bottom electrode system as illustrated in FIG. 3. This is also applicable to a toner bearing member employing a pectinate electrode system as illustrated in FIG. 4.

The pectinate electrode system is described next.

As illustrated in FIGS. 4A and 4B, the toner bearing member 9 has a first electrode pattern 90A having multiple line pattern electrodes 90Aa and a second electrode pattern 90B having multiple line pattern electrodes 90Bb. FIG. 4A is a cross section by a line A-A′ of a top view of FIG. 4B. The electrode pattern 90A and the second electrode pattern 90B are alternately formed parallel to each other in the axis direction of the toner bearing member. An attachment layer 97 is provided on the electrode patterns 90A and 90B containing these multiple line pattern electrodes 90Aa and 90Bb and a surface layer 98 is formed to protect the multiple line pattern electrodes 90Aa and 90Bb.

An insulated cylindrical substrate formed of a synthesis resin such as polyimide, polycarbonate, nylon, fluorine-containing resin, polyacetal, phenol, and polystyrene, or a substrate formed by coating the synthesis resin on an electroconductive cylindrical substrate manufactured by metal-processing of cutting and grinding aluminum, aluminum alloy, nickel, titanium, stainless, etc. can be used as a substrate 93.

Toner manufactured by a pulverization method or a polymerization method can be used as the toner for use in the present disclosure.

Toner having a low melting viscosity is preferable in terms of gloss and color mixture property for full color photocopiers and full color printers. Therefore, a toner binder containing polyester having a sharp melting property is used.

Such a toner tends to cause hot offset. Thus, silicon oil, etc. is typically applied to the fixing member in a full color imaging apparatus.

However, a large-sized complex fixing device including an oil tank and an oil applicator is required to apply silicone oil to the fixing member. In addition, the fixing member is degraded over time and requires maintenance that takes a certain period of time.

Furthermore, the oil is unavoidably attached to recording media such as paper, transparent sheets (film), etc. Above all, the oil attached to a transparent sheet degrades the color tone. Therefore, the toner preferably contains wax to prevent adhesion of the toner without applying oil to the fixing member.

It is preferable to contain at least one of carnauba wax, rice wax and ester wax.

Carnauba wax is a natural wax obtained from leaves of carnauba palm.

Rice wax is also a natural wax manufactured by refining coarse wax produced in the de-waxing or winterization process when refining rice bran wax extracted from rice bran.

Ester wax is synthesized by ester reaction of a single functional straight chain aliphatic acid and a single function straight alcohol.

These wax components can be used alone or in combination.

The addition amount of the wax component is from 0.5 to 20 parts by weight and preferably from 2 to 10 parts by weight.

In the present disclosure, wax components other than carnauba wax, rice wax, and synthesized ester wax can be also used.

For example, polyolefin wax such as polyethylene wax and polypropylene wax can be suitably used.

Any known toner containing these wax components can be suitably used.

The wax component is preferably used to suitably impart shiny feeling to images output by an image forming apparatus.

When the wax components are not contained in the toner, wax can be applied to output sheets after the toner fixing process to impart a similar shiny feeling. However, this method causes problems such that writing or drawing on the sheets with a non-permanent marker becomes slightly difficult and the manufacturing cost increases. Therefore, using toner containing the wax component is preferable.

### EXAMPLES

### Example 1

The present disclosure is described in detail with reference to Examples.

### Liquid Application for Insulation Layer

110 parts of alkyd resin (Beckolite M6401-50, manufactured by DIC Corporation), and 60 parts of melamine resin (SuperBeckamine G-821-60, manufactured by DIC Corporation) are dissolved in 100 parts of methylethylketone.

### Liquid Application for Surface Layer

3 parts of bisphenol Z type polycarbonate resin (Panlite TS-2050, polymerizable material having a molecular weight of 50,000 formed of a structure unit M-15, manufactured by TEIJIN CHEMICALS LTD.) and 0.002 parts of silicone oil (KF-50, manufactured by Shin-Etsu Chemical Co., Ltd.) are dissolved in a liquid mixture of 70 parts of tetrahydrofuran and 30 parts of cyclohexane to prepare a liquid application for surface layer.

### Toner Bearing Member

An insulation layer having a thickness of 20 μm is formed on an aluminum electroconductive substrate having a diameter of 30 mm and a length of 230 mm by a dipping method using the liquid application for surface layer.

This is used as a substrate 91A on which the insulation layer is formed.

A beaten-copper layer having a thickness of 0.8 μm as an electroconductive beaten-metal layer is formed by deposition on the substrate 91A on which the insulation layer is formed. Furthermore, a resist layer having a thickness of 5 μm is applied to the beaten-metal layer. Lattice patterns having a width d of 100 μm, a length L of 200 mm, and a pitch D of 200 μm are formed on the substrate 91A on which the insulation layer covered with copper layer and the resist layer are formed by irradiation by a laser depiction device followed by development in Na₂CO₃ aqueous solution and dipping in FeCl₃ aqueous solution for etching. Thus, the electrode 91Bb having the lattice electrode pattern 91B are formed.

Next, the end of one side of the electrode pattern 91B of the substrate 91A on which the insulation layer is formed having the electrode 91Bb having the predetermined electrode pattern 91B is masked to form the surface layer 98 having a maximum layer thickness of 10 μm covering the electrode 91Bb by a spray coating method using the liquid application for surface layer.

Drying after applying the liquid application for surface layer is conducted at 160° C. for 60 minutes.

The content of cyclohexanone contained in the surface layer of this roller is measured by gas chromatography described in detail layer, which is 3.33% by weight. This content is similarly measured in other Examples.

### Method of Measuring Residual Solvent

This analysis is made by thermal extraction-gas chromatography mass spectrometry (GC-MS).

### Measuring Device

An analyzer (QP-2010, Measuring device control no. C70264100785SA, manufactured by Shimadzu Corporation) is used with a data analysis software (GCMS solution manufactured by Shimadzu Corporation) and pyrolytic equipment (Py-2020S, manufactured by Frontier Laboratories Ltd.)

### Measuring Conditions

Thermal Extraction Condition: Extraction temperature×time: 230° C.×15 minutes

CryoTrap: −190° C. (NB2B. Liq)

Column: Ultra ALLOY-5 L=30 m I.D=0.25 mm Film=0.25 μm

Column Temperature Rising Speed: 50° C. (maintained for one minute) to 100° C. (with a rising temperature speed of 10° C./min) to 300° C. (with a rising temperature speed of 40° C./min) (maintained for seven minutes)

Carrier Gas Pressure: 53.6 kPa constant

Column flowing amount: 1.00 ml/min

Ionization Method: EI method (70 eV)

Infusion mode: Split (1:50)

Library: NIST 20 MASS SPECTRAL LIB.

Measuring mode: Selected ion Monitoring (SIM) method P

P: only m/z: 98 unique to cyclohexanone is detected

m/z: 98: a method also referred to as mass fragmentgraphy in which only a certain mass number in the outflowing material separated by gas chromatography is detected.

The surface layer 98 is applied to the substrate 91A on which the insulation layer is formed with the electrode exposed at the end of the substrate 91A.

The thus manufactured toner bearing member 9 is assembled into the development device 4.

### Condition of Voltage Application to Electrode

An AC bias having an average voltage of −200 V at each moment with peaks of 0 V and −400 V and a frequency of 5 KHz is applied to a terminal provided to the opening mouth of the development device 4 and the electroconductive substrate by an AC power supply.

Black toner (no-wax containing pulverized toner) installed in imagio Neo C320 is supplied to the development device 4.

This development device 4 and the toner are installed into the black station of imagio Neo C320 to output images. The state of toner hopping on the toner bearing member 9, whether the surface layer is peeled off, and whether abnormal images are produced are compared after 1,000 images are output.

### Example 2

The toner bearing member of Example 2 is manufactured in the same manner as in Example 1 except that 80 parts of tetrahydrofuran and 20 parts of cyclohexanone are used instead of 70 parts of tetrahydrofuran and 30 parts of cyclohexanone in the liquid application for the surface layer.

The amount of cyclohexanone contained in the surface layer of the roller is 2.12% by weight.

### Example 3

The toner bearing member of Example 3 is manufactured in the same manner as in Example 1 except that 60 parts of tetrahydrofuran and 40 parts of cyclohexanone are used instead of 70 parts of tetrahydrofuran and 30 parts of cyclohexanone in the liquid application for the surface layer.

The amount of cyclohexanone contained in the surface layer of the roller is 8.85% by weight.

### Example 4

The toner bearing member of Example 4 is manufactured in the same manner as in Example 1 except that the polymerizable material having a molecular weight of 50,000 formed of the structure unit M-15 in the liquid application for the surface layer is replaced with Panlite C-140, a polymerizable material having a molecular weight of 37,500 formed of the structure unit M-1, manufactured by Teijin Chemicals Ltd.

The amount of cyclohexanone contained in the surface layer of the roller is 3.12% by weight.

### Example 5

The toner bearing member of Example 5 is manufactured in the same manner as in Example 1 except that 30 parts of cyclohexanone is used instead of 30 parts of cyclohexanone in the liquid application for the surface layer.

The amount of cyclopentanone contained in the surface layer of the roller is 3.14% by weight.

### Example 6

The toner bearing member of Example 6 is manufactured in the same manner as in Example 1 except that 80 parts of tetrahydrofuran and 20 parts of cyclopentanone are used instead of 70 parts of tetrahydrofuran and 30 parts of cyclohexanone in the liquid application for the surface layer.

The amount of cyclopentanone contained in the surface layer of the roller is 2.06% by weight.

### Example 7

The toner bearing member of Example 7 is manufactured in the same manner as in Example 1 except that 60 parts of tetrahydrofuran and 40 parts of cyclopentanone are used instead of 70 parts of tetrahydrofuran and 30 parts of cyclohexanone in the liquid application for the surface layer.

The amount of cyclopentanone contained in the surface layer of the roller is 6.89% by weight.

### Example 8

The toner bearing member of Example 8 is manufactured in the same manner as in Example 1 except that 95 parts of tetrahydrofuran and 5 parts of cyclohexanone are used instead of 70 parts of tetrahydrofuran and 30 parts of cyclohexanone in the liquid application for the surface layer and the surface layer is formed by a dipping method.

Since the fluidity of the applied layer after the dipping application and before drying is high, the still standing time after application is secured for 10 minutes.

The amount of cyclohexanone contained in the surface layer of the roller is 4.89% by weight.

### Comparative Example 1

The toner bearing member of Comparative Example 1 is manufactured in the same manner as in Example 1 except that 100 parts of cyclohexanone are used instead of 70 parts of tetrahydrofuran and 30 parts of cyclohexanone in the liquid application for the surface layer and the surface layer is formed by a dipping method.

The amount of cyclohexanone contained in the surface layer of the roller is 0.00% by weight.

### Comparative Example 2

The toner bearing member of Comparative Example 2 is manufactured in the same manner as in Example 1 except that 90 parts of tetrahydrofuran and 10 parts of bisphenol Z type polycarbonate resin are used instead of 70 parts of tetrahydrofuran, 30 parts of cyclohexanone and 3 parts by weight of bisphenol Z type polycarbonate resin in the liquid application for the surface layer and the surface layer is formed by a dipping method.

The amount of cyclohexanone contained in the surface layer of the roller is 0.00% by weight.

### Comparative Example 3

The toner bearing member of Comparative Example 3 is manufactured in the same manner as in Example 1 except that the liquid application for the surface layer is used instead of the liquid application for the insulation layer.

The amount of cyclohexanone contained in the surface layer of the roller is 4.78% by weight.

The measuring results and observation results based of each Example and Comparative Example are shown in Table 1.

No surface layer is peeled off or no abnormal hopping occurs after 1,000 images are output in Examples 1 to 8.

In addition, no defect is observed in the output images.

On the other hand, the surface layer is peeled off in Comparative Examples 1 to 3 and no toner hopping occurs, resulting in no output of images.

In Comparative Example 3, while the surface layer is applied in an application tank with the liquid application for surface layer by the dipping method, the electrode layer is seen to be peeling off from the insulation layer and isolate into the liquid application for surface layer.

The toner bearing member that is pulled out of the application tank has a collapsed electrode layer.

Whether the toner particles are hopping on the toner bearing member is observed but no toner particles are hopping.

No image is produced so that the state after 1,000 images are printed is not observed.

TABLE 1

| | Density of cyclohexane | Peeling-off of | | Production of |
|---|---|---|---|---|
| | or cyclopentane in | surface layer | Toner jumping | abnormal image |
| | surface layer | after 1,000 | after 1,000 | after 1,000 |
| | (% by weight) | sheet output | sheet output | sheet output |
| Example 1 | 3.33 | No | Good | No |
| Example 2 | 2.12 | No | Good | No |
| Example 3 | 8.85 | No | Good | No |
| Example 4 | 3.12 | No | Good | No |
| Example 5 | 3.14 | No | Good | No |
| Example 6 | 2.06 | No | Good | No |
| Example 7 | 6.89 | No | Good | No |
| Example 8 | 4.89 | No | Good | No |
| Comparative | 0.00 | Yes | Not jump | Yes |
| Example 1 | | | | |
| Comparative | 0.00 | Yes | Not jump | Yes |
| Example 2 | | | | |
| Comparative | 4.78 | Refer to *1 | Refer to *1 | Refer to *1 |
| Example 3 | | below | below | below |

*1 Since the electrode layer of the roller in Comparative Example 3 collapses, data after 1,000 sheet output is not obtained.

As seen in the detailed description and Examples described above, since the toner bearing member of the present disclosure contains an electroconductive substrate, an insulation layer formed on the electroconductive substrate, multiple electrodes with a constant pitch therebetween, formed on the insulation layer, and a surface layer that covers the multiple electrodes, the surface layer having a polymerizable material including a structure unit represented by the following chemical structure 1 and cyclohexanone and/or cyclopentanone, the insulation layer and the surface layer are secured to be attached to each other, thereby stably forming toner cloud for an extended period of time. Therefore, production of abnormal images is prevented. In addition, a development device that supplies toner to a latent electrostatic image on the surface of the image bearing member and visualizes the latent electrostatic image with the toner can be provided.

This document claims priority and contains subject matter related to Japanese Patent Application no. 2010-009715 filed on Jan. 20, 2010, the entire contents of which are hereby incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A toner bearing member comprising:
an electroconductive substrate;
an insulation layer formed on the electroconductive substrate;
multiple electrodes spaced a constant distance apart, formed on the insulation layer; and
a surface layer that covers the multiple electrodes, the surface layer comprising a polymerizable material comprising a structure unit represented by the following chemical structure 1 and at least one of cyclohexanone and cyclopentanone, 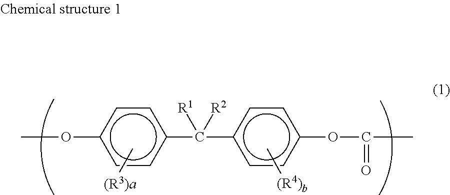
where R₁ and R₂ each independently represent a hydrogen atom, an alkyl group, or an aryl group, or form a cyclic hydrocarbon residual group having 5 to 8 carbon atoms, R₃ and R₄ each independently represent a hydrogen atom, a halogen atom, an alkyl group, or an aryl group, and “a” and “b” represent integers 1 or 2.

2. The toner bearing member according to claim 1, wherein the polymerizable material has a polymerization average molecular weight of from 18,000 to 80,000.

3. The toner bearing member according to claim 1, wherein the insulation layer comprises an alkyd-melamine resin.

4. The toner bearing member according to claim 1, wherein the surface layer comprises at least one of cyclohexanone and cyclopentanone in an amount of from 0.01% to 12% by weight.

5. The toner bearing member according to claim 1, wherein the surface layer comprises a better solvent for the polymerizable material than one or both of cyclohexanone and cyclopentanone.

6. The toner bearing member according to claim 5, wherein the surface layer comprises a liquid application in which at least one of cyclohexanone and cyclopentanone is mixed with the better solvent in an amount of from 3% to 50% by weight.

7. The toner bearing member according to claim 6, wherein the liquid application is dried at 160° C. for 50 to 120 minutes.

8. A development device comprising:
the toner bearing member according to claim 1; and
a toner supplying device that supplies toner to the toner bearing member.

9. An image forming apparatus comprising:
an image bearing member that bears a latent electrostatic image;
a charging device that charges a surface of the image bearing member;
an irradiator that irradiates the surface of the image bearing member to form a latent electrostatic image on the image bearing member;
a development device that develops the latent electrostatic image with toner, the development device comprising the toner bearing member of claim 1;
a transfer device that transfers the visualized toner image onto a recording medium; and
a voltage applicator that applies a voltage between multiple electrodes of the toner bearing member and the image bearing member to form an electric field that is periodically reversed.
